(19) United States
(12) Patent Application Publication
(10) Pub. No.: US 2020/0153002 A1
(43) Pub. Date: May 14, 2020

(54) FUEL CELL POWERED WASTE MANAGEMENT SYSTEM

(71) Applicant: Anderson Industries, LLC, Webster, SD (US)

(72) Inventors: Kory Anderson, West Fargo, ND (US); Daniel Ewert, Lake Park, MN (US)

(21) Appl. No.: 16/548,145

(22) Filed: Aug. 22, 2019

Related U.S. Application Data
(60) Provisional application No. 62/758,374, filed on Nov. 9, 2018.

(51) Int. Cl. H01M 8/04014; B60L 53/54; B01D 33/11; C02F 1/02

(52) U.S. Cl. CPC H01M 8/04022; C02F 1/02; B01D 33/11; B60L 53/54

(57) ABSTRACT

A waste management system comprises a fuel cell to generate electricity, thermal energy and water. The waste management system further comprises a waste treatment system operatively coupled to the fuel cell, the waste treatment system to utilize the generated electricity to separate wastewater into solid waste and water.

### CROSS REFERENCE TO RELATED APPLICATIONS

This application claims the benefit of U.S. Provisional Patent Application No. 62/751,399, filed on Oct. 26, 2018 and U.S. Provisional Patent Application No. 62/758,374, filed on Nov. 9, 2018, the disclosure of which are incorporated herein by reference in their entirety.

### TECHNICAL FIELD

Aspects and implementations of the present disclosure relate to a waste management system and, in particular, a waste management system powered by a fuel cell.

### BACKGROUND

Waste treatment is the process of removing contaminants from wastewater. Physical, chemical and biological processes are used to remove contaminants and produce treated wastewater that is safe enough to release into the environment.

### BRIEF DESCRIPTION OF THE DRAWINGS

Embodiments and implementations of the present disclosure will be understood more fully from the detailed description given below and from the accompanying drawings of various aspects and implementations of the disclosure, which, however, should not be taken to limit the disclosure to the specific embodiments or implementations, but are for explanation and understanding only.

FIG. 1 illustrates an example configuration of a waste management system powered by a fuel cell in accordance with embodiments of the present disclosure.

FIG. 2 is a cross section of a rotary vacuum drum drying system in accordance with one embodiment of the present disclosure.

FIG. 3 illustrates a configuration with the vacuum drum dryer surrounded by other system components such as tanks and pumps that may be connected to the control system of the waste management system.

FIG. 4 is a block diagram that illustrates an example of a telematics system, in accordance with an embodiment of the disclosure.

FIG. 5 is an illustration of an example of a control system of a waste management system selecting a bio-digester to provide methane in accordance with embodiments of the disclosure.

FIG. 6 depicts a flow diagram of a method for operating a fuel cell powered waste management system in accordance with embodiments of the disclosure.

FIG. 7 illustrates a diagrammatic representation of a machine in the example form of a computer system.

### DETAILED DESCRIPTION

Aspects and implementations of the present disclosure are directed to a waste management system powered by a fuel cell. A reaction within the fuel cell may convert a hydrogen fuel into the byproducts of electricity, thermal energy (e.g., heat) and water/water vapor. The electricity generated by the fuel cell may be used to power a waste treatment system, such as a vacuum drum dryer or a belt press.

In the event of natural disasters, major system failures or any other situation resulting in infrastructure shut downs in which waste systems are no longer active or functional to serve the needs of a group of people there is a need for a mobile or temporary system. Additionally, in underdeveloped urban environments, installing a conventional sewer system for wastewater treatment may be impractical and cause the relocation of thousands of residents. Accordingly, there is a need for a portable waste treatment system that can be installed in such environments.

In a conventional waste management system, power to run a wastewater treatment system (e.g., vacuum drum dryer, belt press, etc.) is received from an external power supply, such as a power plant, or from an internal combustion engine. However, in the event of a natural disaster connections to external power supplies may be disrupted. In underdeveloped environments, external power sources may be unavailable or unreliable. The use of an internal combustion engine is also undesirable in urban environments due to noise pollution and emissions generated by the internal combustion engine affecting the nearby population. Additionally, in comparison to a fuel cell stack, an internal combustion engine is heavy and difficult to maneuver, making a waste management system powered by an internal combustion engine more difficult to transport to remote areas, crowded urban environments or areas affected by a natural disaster.

The advantage of using a fuel cell stack compared to an internal combustion engine or an external power source is the improvement in efficiency of fuel to produce output power, the relative portability of a fuel cell powered system and the reduced noise pollution and emissions from a fuel cell powered system. Compared to an internal combustion engine, a fuel cell stack is relatively lightweight and has a higher output power to weight ratio. A waste management system having a fuel cell is significantly lighter and easier to transport than a similar waste management system powered by an internal combustion engine. Additionally, unlike an internal combustion engine, the only byproducts of the reaction within the fuel cell are thermal energy and water vapor, reducing the emissions of the waste management system. Furthermore, compared to an internal combustion engine, the operation of a fuel cell is relatively silent, reducing the noise pollution caused by the waste management system during operation.

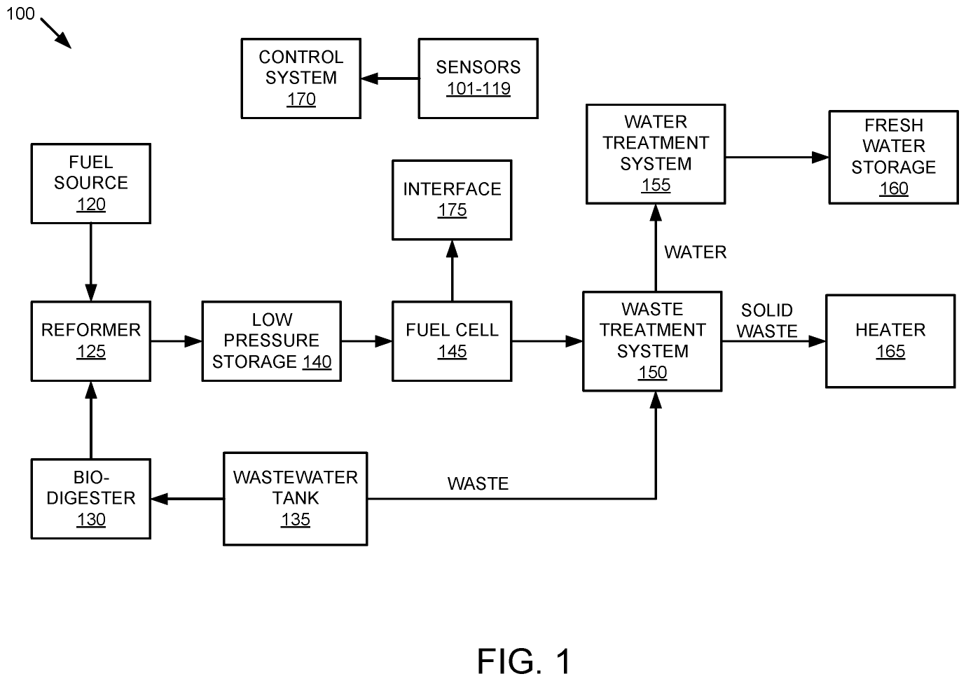

FIG. 1 illustrates an example configuration of a waste management system 100 powered by a fuel cell in accordance with embodiments of the present disclosure. In some embodiments, the waste management system 100 may be a mobile unit capable of being transported as a package to a destination. For example, the waste management system 100 may be contained within a housing capable of being towed, airlifted or otherwise transported to a destination. In embodiments, the waste management system 100 may be a permanently installed system at a desired location.

In the waste management system 100, a fuel source 120 stores a fuel that is to be provided to the fuel cell 145. The fuel source 120 may store a hydrocarbon fuel, such as hydrogen, carbon monoxide, methanol, methane, gasoline, diesel, jet fuel or other hydrocarbon fuels. In some embodiments, fuel source 120 may be a compressed air cylinder storing pure hydrogen. The fuel source 120 is operatively coupled to the fuel cell 145 to provide fuel from fuel source 120 to the fuel cell 145. For example, one or more hoses or tubes may be coupled between the fuel source 120 and the fuel cell 145 to provide the fuel to the fuel cell 145. In embodiments, one or more pumps may be utilized to move the fuel from the fuel source 120 to the fuel cell 145.

In embodiments, fuel from the fuel source 120 may be supplemented or replaced with fuel generated from wastewater to be treated by the waste management system 100. Wastewater, such as sewage, may be stored in a wastewater tank 135 for subsequent processing. One or more bio-digesters 130 may be operatively coupled to the wastewater tank 135 and the reformer 125. The bio-digester 130 is a tank that digests organic material (e.g., wastewater) biologically. For example, the bio-digester 130 may contain bacteria that digest the wastewater and produce methane.

In some embodiments, a reformer 125 may be operatively coupled to fuel source 120 and/or bio-digester 130. The reformer 125 may be operatively coupled between the fuel source 120, bio-digester 130 and the fuel cell 145 to extract hydrogen from the hydrocarbon fuel provided by fuel source 120 and/or the methane provided by the bio-digester 130. An example reformer 125 may be a steam reformer that is configured to cause a reaction between steam at a high temperature and pressure with a hydrocarbon fuel source, such as methanol, in the presence of a nickel catalyst. In embodiments, other types of reformers 125 may be used to extract hydrogen from a hydrocarbon fuel.

In embodiments, upon extraction of the hydrogen from the hydrocarbon fuel by the reformer 125, the extracted hydrogen may be provided to a low pressure storage 140 that is operatively coupled to the reformer 125. Low pressure storage 140 may be a storage system, such as a storage tank or container, which is configured to store the extracted hydrogen at low pressures of approximately one atmosphere. The low pressure storage 140 may provide additional advantages to the waste management system 100 since storing the extracted hydrogen at a low pressure greatly reduces the risk of explosion and, in the event that the low pressure storage 140 is ruptured, the hydrogen will be released at a much slower rate than a pressurized hydrogen storage system. In some embodiments, rather than storing the extracted hydrogen at the low pressure storage 140, the extracted hydrogen may be provided directly from reformer 125 to fuel cell 145.

The low pressure storage 140 may be operatively coupled to the fuel cell 145 to provide the extracted hydrogen stored at the low pressure storage 140 to the fuel cell 145. The fuel cell 145 converts energy from the fuel through an electrochemical reaction of the fuel with oxygen or another oxidizing agent. The fuel cell 145 can include an anode, an electrolyte and a cathode. At the anode a catalyst oxidizes the fuel, turning the fuel into positively charged ions and negatively charged electrons. The positively charged ions pass through the electrolyte, while the negatively charged electrons cannot pass through the electrolyte. The negatively charged electrons travel through a wire to create electric current. The negatively charged electrons are then reunited with the positively charged ions at the cathode, where the negatively charged electrons react with the positively charges ions to produce water/water vapor and heat. Various types of fuel cells 145 may be used in various embodiments of the disclosure depending on a type of fuel of the fuel source. Examples of types of fuel cells that may be used include, but are not limited to, proton exchange membrane fuel cells (PEMFCs), phosphoric acid fuel cells (PAFCs), solid acid fuel cells (SAFCs), alkaline fuel cells (AFC), solid oxide fuel cells (SOFCs), molten carbonate fuel cells (MCFCs) and electric storage fuel cells. The fuel cell 145 may generate electricity using either a pure hydrogen fuel source or extracted hydrogen from a hydrocarbon fuel. Other byproducts of the reaction within the fuel cell 145 may include water vapor and thermal energy. Embodiments of the disclosure may capture and utilize these byproducts, providing further advantages over a conventional waste management system.

In embodiments, the fuel cell 145 may be operatively coupled to an interface 175 to provide electricity generated by fuel cell 145 to one or more auxiliary devices (not shown). The interface 175 may be any type of interface capable of providing electricity to an auxiliary device. For example, interface 175 may be an electrical outlet(s), electric terminals, etc.

The fuel cell 145 is operatively coupled to a waste treatment system 150 for the treatment of wastewater. The fuel cell 145 may provide electricity to power the waste treatment system 150. In embodiments, the fuel cell 145 may also provide water/water vapor and/or thermal energy for use by the waste treatment system 150. For example, the waste treatment system 150 may use the thermal energy to dry the waste material. In another example, the waste treatment system 150 may use the water/water vapor to make steam for purification processes, us the water to support various processes of waste treatment, or add the water/water vapor to the water that is extracted by the waste treatment process of the waste treatment system 150.

The waste treatment system 150 may be operatively coupled to the wastewater tank 135 and receive wastewater from the wastewater tank 135 for treatment. The waste treatment system 150 may separate the wastewater into solid waste and liquid/water. In an embodiment, the waste treatment system 150 may be a belt press/belt filter. The belt press may pass a pair of filtering cloths and belts through a system of rollers to separate the wastewater into liquid/water and a solid cake (e.g., solid waste). In embodiments, the waste treatment system 150 may be a vacuum drum drying system, as will be described in further detail below. In embodiments, the waste treatment system 150 may be a sand filter. In some embodiments, other types of waste treatment systems may be used to separate the wastewater into solid waste and liquid/water.

In embodiments, a water treatment system 155 may be operatively coupled to waste treatment system 150. The water treatment system 155 may receive the water from the waste treatment system 150 and sterilize and filter the water for subsequent use. The water treatment system 155 may include one or more filters to filter the water, one or more UV lights to sterilize the water and/or any other components configured to sterilize and filter the water for subsequent use. In some embodiments, electricity generated by the fuel cell 145 may be provided to the water treatment system 155 to power one or more components of the water treatment system. Upon filtering and sterilizing the water to produce fresh water, the water treatment system 155 may provide the fresh water to fresh water storage 160 for subsequent use. The fresh water storage 160 may be a storage tank, bladder, reservoir, or any other type of storage for fresh water produced by the waste management system 100. In embodiments, at least a portion of the fresh water from fresh water storage 160 may be provided to the waste treatment system 150 for use in the waste treatment process.

In embodiments, the solid waste produced by the waste treatment system 150 may be provided to a heater 165. The heater 165 may use the solid waste as fuel to create heat.

The waste management system may further include a control system 170 to monitor and control the components of the waste management system 100. The control system 170 may include a processing device and may be operatively coupled to sensors 101-119, as well as other sensors, at various locations throughout the waste management system 100. Aspects of the control system 170 will be discussed in further detail below.

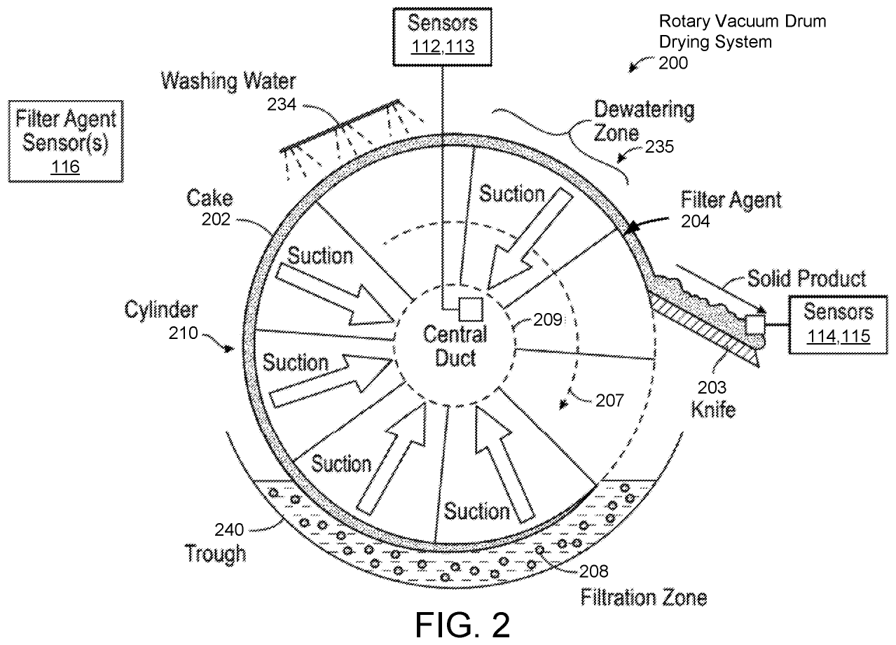

FIG. 2 is a cross section of a rotary vacuum drum drying system 200 in accordance with one embodiment of the present disclosure. In embodiments, the vacuum drum drying system 200 may correspond to the waste treatment system 150 of FIG. 1. In this embodiment, rotary vacuum drum drying system 200 includes a central component composed of a perforated cylinder 210 covered with a breathable membrane cover, with a removable filter agent 204 coating. The cylinder 210 rotates 207 along its transverse axis, with a trough 240 containing a slurry mixture that immerses the lower region of the cylinder.

The portion of the cylinder 210 immersed in the slurry mixture may be defined as a filtration zone 208. By comparison, the portion of the cylinder not immersed in the slurry mixture may be defined as the drying zone. If a water rinse 234 is added to the process of vacuum drum drying, the section of drum immediately past the water rinse may be defined as a dewatering zone 235. In embodiments, water for water rinse 234 may be generated by fuel cell 145 of FIG. 1, as previously described.

As the cylinder 210 rotates 207, a vacuum is applied near the point of rotation in central duct 209, suctioning the slurried material (also referred to as “cake”) 202 on the surface of the cylinder towards the interior of the drum. Air passes through perforations in the surface of the cylinder 210, solids from the slurried material 202 gathers on the filter agent 204. As the cylinder drum 210 rotates, the continued vacuum pressure pulls moisture from the filter agent 204. In certain embodiments, a water rinse 234 is applied to the exterior of the vacuum drum, where the re-wetting of the slurry provides operational benefit for the drying. In one embodiment, at a point of approximately 270 degrees of rotation, a knife or blade 203 scrapes the outside layer of filter agent 204 from the rotating drum cylinder 210 to generate solid product. Alternatively, other scraping of filter agent 204 may be performed at other degrees of rotation of the cylinder. The solid product is then transported from the system.

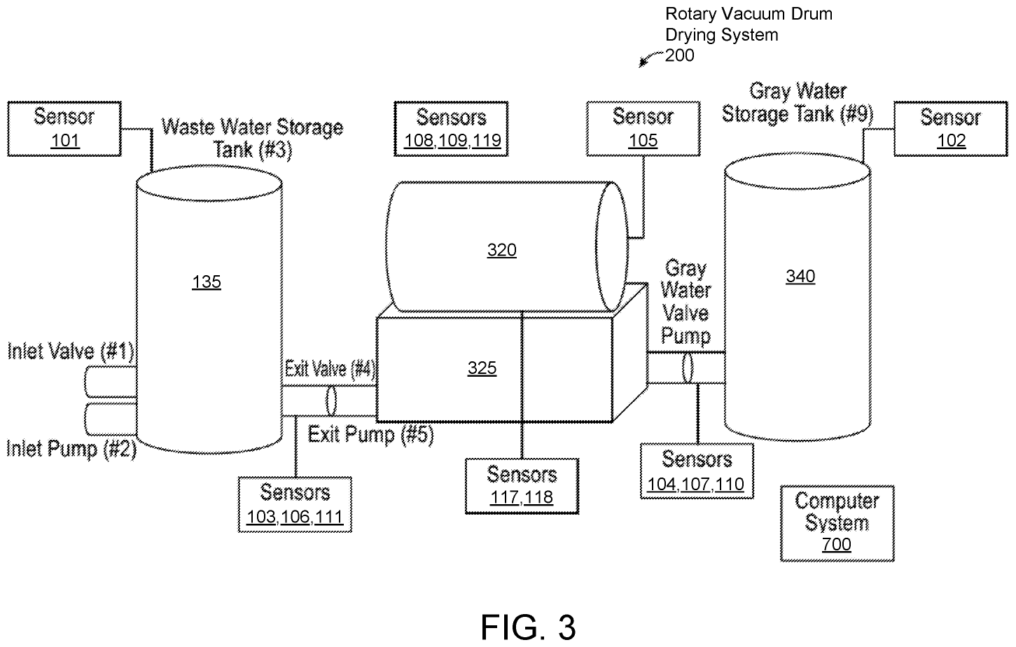

In an instrumented system for separating solids from a slurry mixture, the slurry mixture is initially stored in a wastewater tank 135 of FIG. 1. The slurry mixture from the wastewater tank 135 is pumped into the trough of the vacuum drum dryer for separation into solid and liquid components. The recovered liquids extracted by the drum drying process are stored in a gray water tank 340 of FIG. 3, with the quality of the recovered liquid measured by sensors in the connection between the vacuum drum dryer and the gray water tank.

Embodiments of the present disclosure describe an electronic control and monitoring system for the waste management system. Using advanced sensing, data analytics, processing and communications, the control system (e.g., control system 170 of FIG. 1) allows any time access from any location globally. The control system may be reprogrammed via a telematics system, providing the capability for a remote technical staff to monitor sensors, insert test code, make measurements, and update the programming on any machine worldwide.

The electronic control and monitoring system may be composed of a number of sensors and other components described below to monitor parameters of the rotary vacuum drum drying system. In one embodiment, the rotary vacuum drum drying system 200 includes one or more filter agent sensors 116 to monitor the quantity of unused filter agent (on the drum and/or on reserve). The system may also include a rotational speed sensor 112 for measuring the speed of rotation of the vacuum drum cylinder 210 and vacuum pressure sensor 113 for measuring the vacuum pressure of the system discussed above. In some embodiments, the system may also include a moisture sensor 114 to monitor the moisture content of the removed filter agent 204 and a mass sensor 115 to monitor the mass or rate of mass of the removed filter agent 204. It should be noted that the various sensors are conceptually illustrated in the figures and are not necessarily physically disposed in the locations at which they are shown. For example, sensors 112 and 113 are not necessarily physically disposed within the central duct 209 but, rather, may reside outside the central duct and may also reside beyond the surface of cylinder 210. It should be noted that in one embodiment, the control system may combine both measured parameters (e.g., rotational speed) and derived parameters (e.g., mass of removed material per watt of electrical energy used by the vacuum pump).

FIG. 3 illustrates a configuration with the vacuum drum dryer 320 surrounded by other system components such as tanks and pumps that may be connected to the control system of the waste management system. In this embodiment, the rotary vacuum drum drying system 200 includes vacuum drum dryer 320, wastewater tank 135, and gray water storage tank 340.

Integrating system information with a control system having telematics functionality allows for greater throughput, efficiencies, and cost savings. For example, information regarding the level of the wastewater tank 135 is important to know to ensure that vacuum drum dryer 320 continues to receive wastewater and prevent unnecessary shearing of filter agent. Also, ensuring that the outflow to the clean water outlet, pump, and tank is working prevents backflow into the vacuum drum dryer 320 that could damage systems and cause potentially costly and dangerous system failures.

In some embodiments, the control system may also include other sensors to monitor other parameters of rotary vacuum drum drying system 200. For example, the system may also include sensors 101 and 102 to monitor levels of inlet and outlet fluids in tanks 135 and 340, respectively. The system may also include sensors 103, 104 to monitor flow rates of inlet and outlet fluids to vacuum drum dryer 320, electrical sensors 106, 107 on the power consumed by inlet and outlet pumps, sensor 111 to monitor the solid content of the inlet fluid to vacuum drum dryer 320, and sensor 110 to monitor the clarity of outlet fluid to tank 340. The system may also include a sensor 105 to monitor the electrical power consumption of motors (not illustrated) inside housing base 325 driving vacuum drum dryer 320. The system may also include a sensor 109 for monitoring the ambient humidity levels of the environment in which the vacuum drum dryer 320 is operating. The system may also include sensors 117 and 119 for monitoring the machine vibration and temperatures (used for diagnostics and machine health analysis) of the vacuum drum dryer 320. The system may also include an external sensor 119 to monitor the time of day and calendar day.

The monitored parameters noted above may be used to identify issues, recommend preventative maintenance and/or optimize the efficiency of the waste treatment process. For example, the rotary vacuum drum drying system may be optimized for at least one of throughput of water, drying agent removal, or water removal. Optimizing for the throughput of water might include high rates of vacuum and high rotational rates for the vacuum drum. Optimizing for drying agent removal might be composed of low rates of vacuum and low rates of rotation. Optimizing for water removal might consist of high rates of vacuum and low rates of rotation. These optimization operations may or may not be the same as the settings used to optimize the individual operation of the vacuum drum dryer. In embodiments, the material blade extraction position may be adjusted to reduce the amount of filer material lost per revolution, thereby reducing the frequency that the filter needs to be re-applied to the vacuum drum. To optimize water extraction rates, the level of wastewater in wastewater tank 135 can be maintained to ensure that the rotary vacuum drum drying system continues to receive wastewater and prevent over-shearing of a filter agent. Over-shearing may be prevented by controlling the outflow of wastewater tank 135 to prevent backflow into the vacuum drum. The control system composed of a processing device 702 receives information from the sensors about system 100 and 200 status and performance. In some embodiments, the processing device of the control system may execute a machine learning algorithm. The machine learning algorithm may monitor and adjust parameters of the waste management system to improve performance, suggest preventative maintenance and identify malfunctions of the waste management system.

In embodiments, the control system may transmit the received information from the sensors about waste management system 100 status and performance using a telematics system to a client device, as described in further detail below. In embodiments, the control system may monitor the sensors and use control algorithms to optimize the operation for variations in environmental conditions, such as air temperature, relative humidity, etc. and slurry conditions such as temperature, percent solids, etc. In embodiments, the control system may implement one or more alarms to signal when a particular parameter of the waste management system 100 is above or below a threshold value.

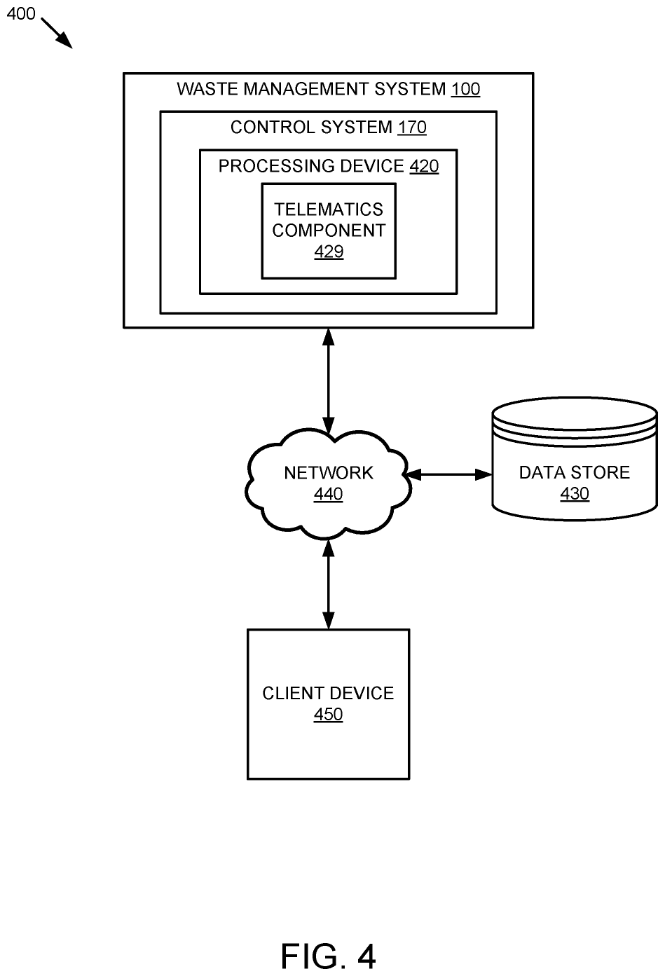

FIG. 4 is a block diagram that illustrates an example of a telematics system 400, in accordance with an embodiment of the disclosure. The telematics system 400 may include control system 170 of waste management system 100, as previously described with respect to FIG. 1. The control system 170 includes a processing device 420 that executes a telematics component 429. In embodiments, the control system 170 may be operatively coupled to a data store 430 and a client device 450 via a network 440. In some embodiments, the data store 430 may reside in the control system 170. In embodiments, the waste management system 100 may include a portable computing device (not shown) that may enable a local user of the waste management system 100 to communicate via audio and/or video with a technician at a different location. Accordingly, a local user of the waste management system 100 with little to no training may be able to identify and remedy issues with the waste management system 100 with the assistance of the technician without the requirement of the technician being present.

The network 440 may be a public network (e.g., the internet), a private network (e.g., a local area network (LAN) or wide area network (WAN)), or a combination thereof. In one embodiment, network 440 may include a wired or a wireless infrastructure, which may be provided by one or more wireless communications systems, such as a WiFi™ hotspot connected with the network 440 and/or a wireless carrier system that can be implemented using various data processing equipment, communication towers (e.g. cell towers), etc.

The client device 450 may be a computing device, such as a personal computer, laptop, cellular phone, personal digital assistant (PDA), gaming console, tablet, etc. In embodiments, the client device 450 may be associated with a human operator of the waste management system 100.

The data store 430 may be a persistent storage that is capable of storing data (e.g., actions, parameters, performance data, location, etc. associated with waste management system 100, as described herein). A persistent storage may be a local storage unit or a remote storage unit. Persistent storage may be a magnetic storage unit, optical storage unit, solid state storage unit, electronic storage units (main memory), or similar storage unit. Persistent storage may also be a monolithic/single device or a distributed set of devices. In embodiments, data store 430 may be a central server or a cloud-based storage system including a processing device (not shown). The central server or the cloud-based storage system may be accessed by control system 170 and/or client device 450.

In embodiments, telematics component 429 may transmit data to client device 450 and/or data store 430. Telematics component 429 may receive, from client device 450, commands corresponding to adjustments to be made to one or more parameters of waste management system 100.

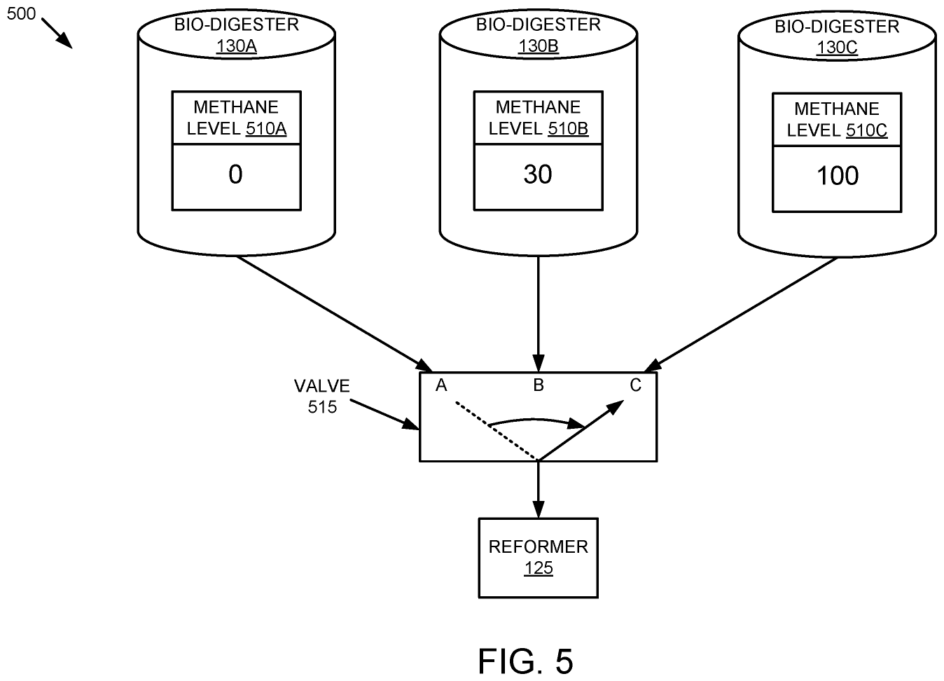

FIG. 5 is an illustration 500 of an example of a control system of a waste management system selecting a bio-digester to provide methane in accordance with embodiments of the disclosure. As previously described, the waste management system may use one or more bio-digesters to convert a portion of the wastewater to methane. In embodiments, the methane may be provided to a reformer, where the hydrogen is extracted from the methane and used as fuel for the fuel cell. Over time, bacteria within the bio-digester may consume the wastewater and produce methane for use by the waste management system. When the methane within one bio-digester of the waste management system has been depleted, it may be advantageous to switch to a different bio-digester that has a greater amount of methane.

Illustration 500 includes bio-digesters 130A-C that each have a corresponding methane level 510A-C. Each of the methane levels 510A-C may be a numerical representation of the amount of methane within each of the corresponding bio-digesters 130A-C. The methane levels 510A-C may be acquired by one or more sensors operatively coupled to bio-digesters 130A-C. Bio-digesters 130A-C may each be operatively coupled to a valve 515 that allows for a particular bio-digester to be selected to provide methane to reformer 125. In some embodiments, the valve 515 may be operatively coupled to and controlled by the control system (not shown) of the waste management system. In embodiments, the valve 515 may be controlled by a client device via a telematics system, as previously described. In an embodiment, the valve 515 may be operated manually. Although illustrated as using a valve 515, in embodiments the waste management system may utilize any type of mechanism or system configured to allow for the selection of a particular bio-digester to provide methane.

In illustration 500, valve 515 is initially positioned to allow bio-digester 130A to provide methane to reformer 125. However, the methane level 510A of bio-digester 130A has reached a value of 0, indicating that the methane in bio-digester 130A has been depleted. In response to the methane level 510A being depleted, a new bio-digester may be selected to provide methane to the reformer 125. In illustration 500, the methane level 510B of bio-digester 130B is 30 and the methane level 510C of bio-digester 130C is 100. Because methane level 510C is greater than methane level 510B, bio-digester 130C may be selected to provide methane to reformer 125. Accordingly, the position of valve 515 may be adjusted to enable bio-digester 130C to provide methane to reformer 125. While bio-digester 130C is providing methane to reformer 125, the digestion process in bio-digesters 130A and 130B may continue, causing methane levels 510A and 510B to rise. Over time, when bio-digester 130C has been depleted, a new bio-digester may be selected to provide methane to the reformer 125.

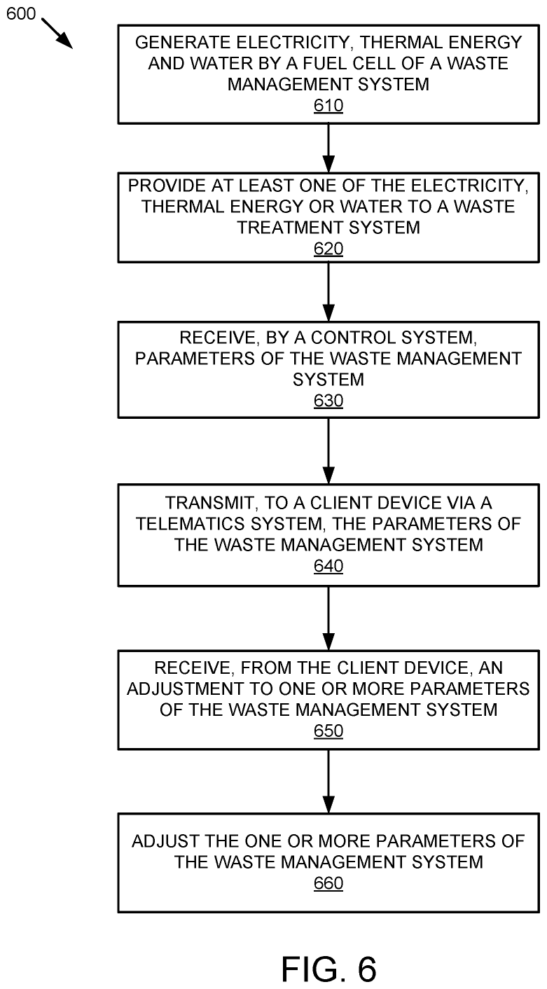

FIG. 6 depicts a flow diagram of a method 600 for operating a fuel cell powered waste management system in accordance with embodiments of the disclosure. In embodiments, various portions of method 600 may be performed by one or more components of waste management system 100 of FIG. 1 and/or telematics system 400 of FIG. 4.

With reference to FIG. 6, method 600 illustrates example functions used by various embodiments. Although specific function blocks (“blocks”) are disclosed in method 600, such blocks are examples. That is, embodiments are well suited to performing various other blocks or variations of the blocks recited in method 600. It is appreciated that the blocks in method 600 may be performed in an order different than presented, and that not all of the blocks in method 600 may be performed.

At block 610, a fuel cell of a waste management system generates electricity, thermal energy and water/water vapor.

At block 620, the electricity generated by the fuel cell is provided to the waste treatment system. In some embodiments, the water/water vapor and/or thermal energy generated by the fuel cell is also provided to the waste treatment system.

At block 630, a control system of the waste management system receives parameters of the waste management system. The control system may receive the parameters from one or more sensors positioned at various locations of the waste management system.

At block 640, the control system of the waste management system transmits the parameters of the waste management system to a client device via a telematics system.

At block 650, the control system receives an adjustment to one or more parameters of the waste management system from the client device via the telematics system. For example, the control system may receive an adjustment to the drum speed of the vacuum drum dryer, fuel cell power output, selected bio-digester, or any other adjustments to any of the operational parameters of the waste management system.

At block 660, the control system adjusts the one or more parameters of the waste management system based on the received adjustment from the client device. For example, if the client device adjusts the drum speed of the vacuum drum dryer from 30 RPM to 40 RPM, then the control system may adjust the drum speed accordingly.

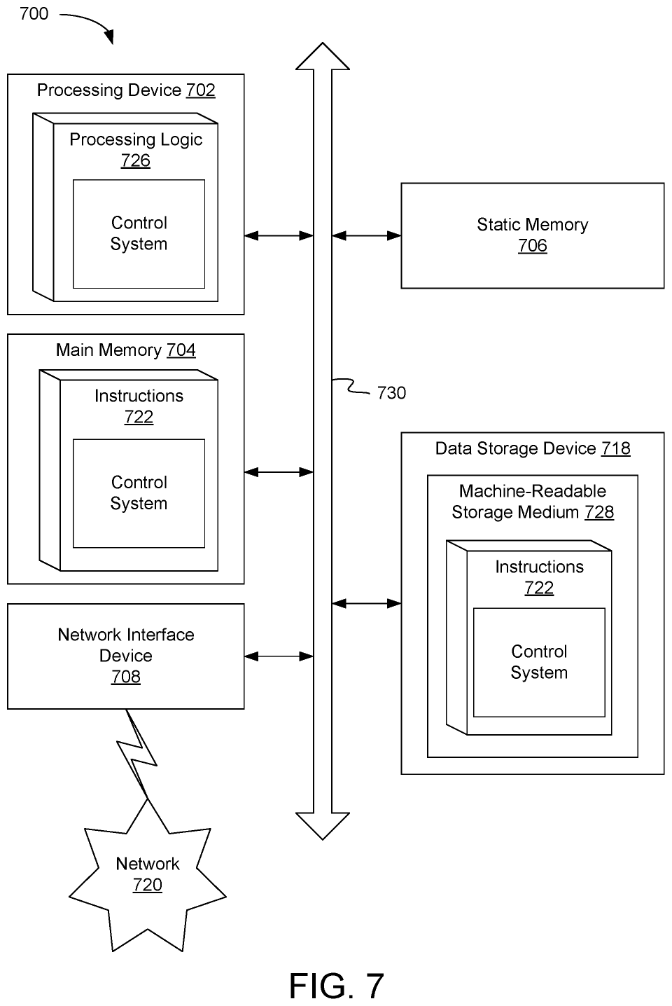

FIG. 7 illustrates a diagrammatic representation of a machine in the example form of a computer system 700 within which a set of instructions, for causing the machine to perform any one or more of the methodologies discussed herein, may be executed. In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a web appliance, a server, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 700 may be representative of a server configured to control the operations of waste management system 100.

The exemplary computer system 700 includes a processing device 702, a user interface display 713, a main memory 704 (e.g., read-only memory (ROM), flash memory, dynamic random access memory (DRAM), a static memory 706 (e.g., flash memory, static random access memory (SRAM), etc.), and a data storage device 718, which communicate with each other via a bus 730. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Processing device 702 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 702 may also be one or more special-purpose processing devices such as an application specific integrated circuit (ASIC), a field programmable gate array (FPGA), a digital signal processor (DSP), network processor, or the like. The processing device 702 is configured to execute processing logic 726, which may be one example of waste management systems 100 and 400 shown in FIGS. 1 and 4, for performing the operations and blocks discussed herein.

The data storage device 718 may include a machine-readable storage medium 728, on which is stored one or more set of instructions 722 (e.g., software) embodying any one or more of the methodologies of functions described herein, including instructions to cause the processing device 702 to execute telematics component 429. The instructions 722 may also reside, completely or at least partially, within the main memory 704 or within the processing device 702 during execution thereof by the computer system 700; the main memory 704 and the processing device 702 also constituting machine-readable storage media. The instructions 722 may further be transmitted or received over a network 720 via the network interface device 708.

The machine-readable storage medium 728 may also be used to store instructions to perform a method for device identification, as described herein. While the machine-readable storage medium 728 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular embodiments may vary from these exemplary details and still be contemplated to be within the scope of the present disclosure.

Reference throughout this specification to “one embodiment” or “an embodiment” means that a particular feature, structure, or characteristic described in connection with the embodiments included in at least one embodiment. Thus, the appearances of the phrase “in one embodiment” or “in an embodiment” in various places throughout this specification are not necessarily all referring to the same embodiment.

Embodiments of the claimed subject matter include, but are not limited to, various operations described herein. These operations may be performed by hardware components, software, firmware, or a combination thereof.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent or alternating manner.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

What is claimed is:

1. A waste management system comprising:
a fuel cell to generate electricity, thermal energy and water; and
a waste treatment system operatively coupled to the fuel cell, the waste treatment system to utilize at least one of the generated electricity, the thermal energy or the water to separate wastewater into solid waste and water.

2. The waste management system of claim 1, wherein the waste treatment system comprises a vacuum drum dryer system.

3. The waste management system of claim 1, wherein the waste treatment system comprises a belt press.

4. The waste management system of claim 1, further comprising:
a wastewater tank to capture and store the wastewater to be processed by the waste treatment system.

5. The waste management system of claim 4, further comprising:
one or more bio-digesters operatively coupled to the wastewater tank to capture methane from the wastewater.

6. The waste management system of claim 1, further comprising:
one or more sensors operatively coupled to the waste management system; and
a control system to monitor operation of the waste management system via the one or more sensors.

7. The waste management system of claim 6, further comprising:
a telematics system operatively coupled to the control system to send and receive information associated with the waste management system.

8. The waste management system of claim 6, wherein the control system comprises a processing device executing a machine learning algorithm to control one or more parameters of the waste management system.

9. The waste management system of claim 1, further comprising:
a fuel reformer operatively coupled to the fuel cell, the fuel reformer to extract hydrogen from a hydrocarbon fuel and provide the hydrogen to the fuel cell.

10. The waste management system of claim 1, further comprising:
a heater operatively coupled to the waste treatment system, the heater to utilize the solid waste as fuel to create thermal energy.

11. The waste management system of claim 1, further comprising:
a water treatment system operatively coupled to the waste treatment system, the water treatment system to filter and sanitize the water.

12. The waste management system of claim 11, further comprising:
a fresh water storage tank operatively coupled to the water treatment system, the fresh water storage tank to store the filtered and sanitized water.

13. The waste management system of claim 1, further comprising:
an interface operatively coupled to the fuel cell, the interface to provide the electricity to one or more auxiliary devices.

14. A method of waste management, comprising:
generating electricity, thermal energy and water by a fuel cell of a waste management system; and
providing at least one of the electricity, the thermal energy or the water to a waste treatment system, wherein the waste treatment system receives wastewater and separates the wastewater into solid waste and water.

15. The method of waste management of claim 14, wherein the waste treatment system comprises a vacuum drum dryer.

16. The method of waste management of claim 14, further comprising:
receiving, by a control system comprising a processing device from a plurality of sensors of the waste management system, a plurality of parameters of the waste management system; and
adjusting, by the control system, one or more parameters of the plurality of parameters.

17. The method of waste management of claim 16, further comprising:
transmitting, to a client device via a telematics system, the plurality of parameters of the waste management system; and
receiving, from the client device, an adjustment to the one or more parameters of the plurality of parameters, wherein receiving the adjustment to the one or more parameters causes the control system to adjust the one or more parameters.

18. The method of waste management of claim 16, wherein the processing device of the control system executes a machine learning algorithm and wherein the machine learning algorithm determines to adjust the one or more parameters of the plurality of parameters.

19. The method of claim 14, further comprising:
providing the solid waste to a heater, wherein the heater utilizes the solid waste as fuel to create heat.

20. The method of claim 14, further comprising:
providing the water to a water treatment system, wherein the water treatment system filters and sanitizes the water.
